(19) United States
(12) Patent Application Publication
(10) Pub. No.: US 2026/0017654 A1
(43) Pub. Date: Jan. 15, 2026

(54) Systems for Secure Transaction Authentication and Methods of Use Thereof

(71) Applicant: William Alexander Dodd, Wylie, TX (US)

(72) Inventor: William Alexander Dodd, Wylie, TX (US)

(21) Appl. No.: 18/815,301

(22) Filed: Aug. 26, 2024

Related U.S. Application Data
(60) Provisional application No. 63/669,132, filed on Jul. 9, 2024.

(51) Int. Cl. G06Q 20/40

(52) U.S. Cl. CPC G06Q 20/4012

(57) ABSTRACT

A system is herein disclosed. The system comprises a processor and a memory. The memory stores instructions that cause the processor to: transmit a system identifier to a finance system; receive a DIDC from the finance system, the DIDC being associated with a user account having a credit account number; generate a keyset book having an authentication keyset based on an authorization code comprising a user key portion and a finance key portion; and a tracking field having at least the DIDC; decompose the authentication keyset into a user key and a finance key; store the user key in the memory; transmit the finance key to the finance system; receive an input indicative of a transaction request; initialize the transaction request with the finance system by transmitting the user key to the vendor; and receive an approval of the transaction request from the finance system having authenticated a rejoined keyset.

### CROSS-REFERENCE TO RELATED APPLICATIONS

The present patent application claims priority to the provisional patent application identified by U.S. Ser. No. 63/669,132, filed on Jul. 9, 2024; the entire contents of each of which are hereby incorporated herein by reference.

### BACKGROUND

In today's digital age, financial transactions are increasingly conducted online and through various electronic means. While this convenience has revolutionized the way people manage their finances, it has also opened the door to a growing number of security threats, such as identity theft, fraud, and unauthorized access to sensitive financial information. As a result, there is a pressing need for more robust and secure authentication methods to protect users and their financial assets from these risks.

Traditionally, financial transaction authentication has relied on methods such as passwords, personal identification numbers (PINs), and security questions. However, these methods have proven to be vulnerable to various forms of attack, including phishing, social engineering, and brute-force hacking. Moreover, the increasing sophistication of cyber criminals has led to the development of advanced tools and techniques that can easily bypass these conventional security measures, leaving users exposed to potential financial losses and privacy breaches.

To address these challenges, the financial industry has been actively seeking innovative solutions that can provide a higher level of security without compromising user experience. Some of the recent advancements in this field include biometric authentication, two-factor authentication, and hardware-based security tokens. While these methods have shown promise in enhancing security, they often come with their own set of limitations, such as high implementation costs, user inconvenience, and potential vulnerabilities.

Therefore, a need exists for a more secure, user-friendly, and cost-effective financial transaction authentication system that can effectively prevent theft, protect users' financial assets, and protect the financial institutions that provide the financial services.

### SUMMARY

The problem of effectively preventing theft, protecting users' financial assets, and protecting the financial institutions is solved by the systems and methods herein disclosed. The systems and methods include a system comprising a processor and a memory. The memory comprises a non-transitory processor-readable medium storing processor-executable instructions that when executed by the processor, causes the processor to: transmit a unique system identifier to a finance system; receive a device identification code from the finance system and store the device identification code in the memory where the device identification code is associated with a user account having a credit account number; generate a keyset book having one or more authentication keyset based on an authorization code comprising a user key portion and a finance key portion and a tracking field having at least the device identification code; decompose at least one authentication keyset of the one or more authentication keysets into a user key and a finance key where the user key includes: the tracking field, the user key portion, a parity value and a user validity code, and where the finance key includes: the tracking field, the finance key portion, one or more CRC bit, and a finance validity code; store the user key in the memory; transmit the finance key to the finance system; receive an input indicative of a transaction request with a vendor; initialize the transaction request with the finance system by transmitting the user key to the vendor; and receive an approval of the transaction request from the finance system having authenticated a rejoined keyset.

In another embodiment, the systems and methods include a method comprising: identifying a user account by instituting a relationship between a user system operated by an account holder and a financial system; linking the user system to the user account by determining ownership of the user system; generating an authentication keyset based on a tracking field and an authorization code; decomposing at least one authentication keyset into a user key and a finance key; transmitting the finance key to the finance system; and providing the user key to a vendor as part of a transaction request to authorize the transaction with the finance system.

Implementations of the above techniques include methods, apparatus, systems, and computer program products. One such computer program product is suitably embodied in a non-transitory computer-readable medium that stores instructions executable by one or more processors. The instructions are configured to cause the one or more processors to perform the above-described actions.

The details of one or more implementations of the subject matter of this specification are set forth in the accompanying drawings and the description below. Other aspects, features and advantages will become apparent from the description, the drawings, and the claims.

The foregoing Summary provides an overview of certain selected implementations or embodiments disclosed herein, and is not intended to describe every aspect, embodiment, implementation, feature, or advantage of the disclosure exhaustively or comprehensively. Therefore, this Summary should not be construed in such a way to limit the scope of this disclosure or to limit the scope of the claims. The details of one or more implementation or embodiment disclosed herein are set forth in the accompanying drawings and descriptions below. Other aspects, features, implementations, embodiments, and advantages will become readily apparent in view of the description, the drawings, and the claims set forth herein.

### BRIEF DESCRIPTION OF DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a diagram of an exemplary embodiment of an authentication system constructed in accordance with the present disclosure.

FIG. 2 is a diagram of an exemplary embodiment of the user system of the authentication system constructed in accordance with the present disclosure.

FIG. 3 is a diagram of an exemplary embodiment of the financial system constructed in accordance with the present disclosure.

FIG. 4 is a flow diagram of an exemplary embodiment of an institution process constructed in accordance with the present disclosure.

FIG. 5 is a diagram of an exemplary embodiment of an authentication keyset construction diagram constructed in accordance with the present disclosure.

FIG. 6 is a data diagram of an exemplary embodiment of a keyset book comprising the authentication keysets of FIG. 5 constructed in accordance with the present disclosure.

FIG. 7 is a process flow diagram of an exemplary embodiment of a keyset creation process constructed in accordance with the present disclosure.

FIG. 8 is a process flow diagram of an exemplary embodiment of a keyset decomposition process constructed in accordance with the present disclosure.

FIG. 9A is a block diagram of an exemplary embodiment of the user key constructed in accordance with the present disclosure.

FIG. 9B is a block diagram of an exemplary embodiment finance key constructed in accordance with the present disclosure.

FIG. 10 is process flow diagram of an exemplary embodiment of an activation process constructed in accordance with the present disclosure.

FIG. 11 is a process flow diagram of an exemplary embodiment of a reconstitution and validation process constructed in accordance with the present disclosure.

FIG. 12 is a diagram of an exemplary embodiment of a credit exchange system constructed in accordance with the present disclosure.

FIG. 13 is an illustration of an exemplary embodiment of a hardware authentication device constructed in accordance with the present disclosure.

FIG. 14 is a depiction of an exemplary embodiment of the user system constructed in accordance with the present disclosure.

FIG. 15 is a depiction of an exemplary embodiment of the user application on the output device of the user system constructed in accordance with the present disclosure.

FIG. 16 is a depiction of an exemplary embodiment of a Point of Sales terminal constructed in accordance with the present disclosure.

FIG. 17 is a depiction of an exemplary embodiment of an Automatic Teller Machine application screen constructed in accordance with the present disclosure.

FIG. 18 is a depiction of an exemplary embodiment of an Automatic Teller Machine transaction receipt constructed in accordance with the present disclosure.

### DETAILED DESCRIPTION

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted. The disclosure is capable of other embodiments or of being practiced or carried out in various ways. Also, it is to be understood that the phraseology and terminology employed herein is for purposes of description and should not be regarded as limiting.

As used in the description herein, the terms “comprises,” “comprising,” “includes,” “including,” “has,” “having,” or any other variations thereof, are intended to cover a non-exclusive inclusion. For example, unless otherwise noted, a process, method, article, or apparatus that comprises a list of elements is not necessarily limited to only those elements but may also include other elements not expressly listed or inherent to such process, method, article, or apparatus.

Further, unless expressly stated to the contrary, “or” refers to an inclusive and not to an exclusive “or”. For example, a condition A or B is satisfied by one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more, and the singular also includes the plural unless it is obvious that it is meant otherwise. Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to computing tolerances, computing error, manufacturing tolerances, measurement error, wear and tear, stresses exerted on various parts, and combinations thereof, for example.

As used herein, any reference to “one embodiment,” “an embodiment,” “some embodiments,” “one example,” “for example,” or “an example” means that a particular element, feature, structure, or characteristic described in connection with the embodiment is included in at least one embodiment and may be used in conjunction with other embodiments. The appearance of the phrase “in some embodiments” or “one example” in various places in the specification is not necessarily all referring to the same embodiment, for example.

The use of ordinal number terminology (i.e., “first”, “second”, “third”, “fourth”, etc.) is solely for the purpose of differentiating between two or more items and, unless explicitly stated otherwise, is not meant to imply any sequence or order of importance to one item over another.

The use of the term “at least one” or “one or more” will be understood to include one as well as any quantity more than one. In addition, the use of the phrase “at least one of X, Y, and Z” will be understood to include X alone, Y alone, and Z alone, as well as any combination of X, Y, and Z.

Where a range of numerical values is recited or established herein, the range includes the endpoints thereof and all the individual integers and fractions within the range, and also includes each of the narrower ranges therein formed by all the various possible combinations of those endpoints and internal integers and fractions to form subgroups of the larger group of values within the stated range to the same extent as if each of those narrower ranges was explicitly recited. Where a range of numerical values is stated herein as being greater than a stated value, the range is nevertheless finite and is bounded on its upper end by a value that is operable within the context of the invention as described herein. Where a range of numerical values is stated herein as being less than a stated value, the range is nevertheless bounded on its lower end by a non-zero value. It is not intended that the scope of the invention be limited to the specific values recited when defining a range. All ranges are inclusive and combinable.

Circuitry, as used herein, may be analog and/or digital components, or one or more suitably programmed processors (e.g., microprocessors) and associated hardware and software, or hardwired logic. Also, “components” may perform one or more functions. The term “processing component,” may include hardware, such as a processor (e.g., microprocessor), an application specific integrated circuit (ASIC), a field programmable gate array (FPGA), a combination of hardware and software, software, and/or the like. The term “processor” as used herein means a single processor or multiple processors working independently or together to collectively perform a task.

Software may include one or more computer readable instruction that when executed by one or more component, e.g., a processor or a processing component, causes the component to perform a specified function. It should be understood that the algorithms described herein may be stored on one or more non-transitory computer-readable medium. Exemplary non-transitory computer-readable media may include a non-volatile memory, a random-access memory (RAM), a read only memory (ROM), a CD-ROM, a hard drive, a solid-state drive, a flash drive, a memory card, a DVD-ROM, a Blu-ray Disk, a laser disk, a magnetic disk, an optical drive, combinations thereof, and/or the like.

Such non-transitory computer-readable media may be electrically based, optically based, magnetically based, resistive based, and/or the like. Further, the signals described herein may be generated by the components and result in various physical transformations.

As used herein, the terms “network-based,” “cloud-based,” and any variations thereof, are intended to include the provision of configurable computational resources on demand via interfacing with a computer and/or computer network, with software and/or data at least partially located on a computer and/or computer network.

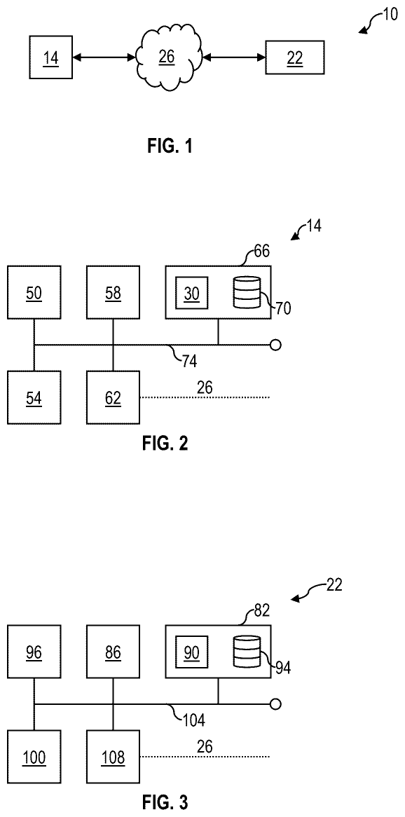

Referring now to the drawings, and in particular to FIG. 1, shown therein is a diagram of an exemplary embodiment of an authentication system 10 constructed in accordance with the present disclosure. The authentication system 10 generally includes one or more user system 14 in communication with a financial system 22. The user system 14 may communicate with the financial system 22 via a network 26. In one embodiment, a user may access the user application 30 (FIG. 2) via a user interface 32 (discussed below) to interact with the user system 14. In one embodiment, the financial system 22 is a computing system, such as a (cloud-based) server system operated by, for example, a financial institution or issuing bank, or the like.

The network 26 may permit bi-directional communication of information and/or data between the user system 14 and the financial system 22. The network 26 may interface with the user system 14 and the financial system 22 in a variety of ways. For example, in some embodiments, the network 26 may interface by optical and/or electronic interfaces, and/or may use a plurality of network topographies and/or protocols including, but not limited to, Ethernet, TCP/IP, circuit switched path, combinations thereof, and/or the like, as described below.

In one embodiment, the network 26 may be the Internet and/or another network. For example, if the network 26 is the Internet, a user interface (e.g., an application 90) of the authentication system 10 may be delivered through a series of web pages or private internal web pages of a company or corporation, which may be written in hypertext markup language (HTML/PHP/JavaScript), for example, and may be accessible by the user system 14. It should be noted that the user interface of the authentication system 10 may be another type of interface including, but not limited to, a Windows-based application, a tablet-based application, a mobile web interface, an application running on a mobile device, a virtual-reality interface, an augmented-reality interface, and/or the like.

The network 26 may be almost any type of network. For example, in some embodiments, the network 26 may be a version of an Internet network (e.g., exist in a TCP/IP-based network). In one embodiment, the network 26 is the Internet. It should be noted, however, that the network 26 may be almost any type of network and may be implemented as the World Wide Web (or Internet), a local area network (LAN), a wide area network (WAN), an LPWAN, a LoRaWAN, a metropolitan network, a wireless network, a cellular network, a Bluetooth network, a Global System for Mobile Communications (GSM) network, a code division multiple access (CDMA) network, a 3G network, a 4G network, an LTE network, a 5G network, a satellite network, a radio network, an optical network, a cable network, a public switched telephone network, an Ethernet network, a short-wave wireless network, a long-wave wireless network, combinations thereof, and/or the like. It is conceivable that in the near future, embodiments of the present disclosure may use more advanced networking topologies.

The number of devices and/or networks illustrated in FIG. 1 is provided for explanatory purposes. In practice, there may be additional devices and/or networks, fewer devices and/or networks, different devices and/or networks, or differently arranged devices and/or networks than are shown in FIG. 1. Furthermore, two or more of the devices illustrated in FIG. 1 may be implemented within a single device, or a single device illustrated in FIG. 1 may be implemented as multiple, distributed devices, operating separately or together. Additionally, or alternatively, one or more of the devices of the authentication system 10 may perform one or more functions described as being performed by another one or more of the devices of the authentication system 10. Devices of the authentication system 10 may interconnect via wired connections, wireless connections, or a combination thereof.

Referring now to FIG. 2, shown therein is a diagram of an exemplary embodiment of the user system 14 of the authentication system 10 constructed in accordance with the present disclosure. In some embodiments, the user system 14 may include, but is not limited to, implementations as a personal computer, a cellular telephone, a smart phone, a smart card, a network-capable television set, a tablet, a laptop computer, a desktop computer, a server computer, a network-capable handheld device, and/or the like.

In some embodiments, the user system 14 may include one or more input device 50 (hereinafter “input device 50”), one or more output device 54 (hereinafter “output device 54”), one or more processor 58 (hereinafter “processor 58”), one or more communication device 62 (hereinafter “communication device 62”) capable of interfacing with the network 26, one or more memory 66 (hereinafter “memory 66”) storing processor-executable code and/or software application(s) 30 (hereinafter “user application 30”) and one or more database 70 (hereinafter “database 70”). The input device 50, output device 54, processor 58, communication device 62, and memory 66 may be connected via a path 74 such as a data bus that permits communication among the components of the user system 14. Each component of the user system 14 may be partially or completely network-based or cloud-based, and may or may not be located in a single physical location.

The memory 66 may be one or more non-transitory processor-readable medium storing processor-executable instructions that when executed by the processor 58 causes the processor 58 to perform one or more function to affect other components of the user system 14. The memory 66 may store the user application 30, e.g., as processor-executable instructions, that, when executed by the processor 58, causes the user system 14 to perform an action such as communicate with or control one or more component of the user system 14 and/or, via the network 26, with, or control, the financial system 22. The memory 66 may be one or more memory 66 working together, or independently, to store processor-executable code and may be located locally or remotely to the processor 58 or each other, e.g., accessible via the network 26. In some embodiments, the memory 66 may further store account identification information associated with a particular user, such as a primary account number, personal identifiable information, including an account username, a user's name, a birthdate, an address, a telephone number, other contact information, and/or the like. The account identification information may further include, for example, an account expiration date, transaction security codes, and available credit limit, and/or the like.

In some embodiments, the user application 30 may be stored as a compiled application file, such as an executable file, for example, or in a structure (or unstructured) format, such as, e.g., in a non-compiled file. In one embodiment, the user, interacting with the user interface 32 of the user system 14 via the input device 50 may utilize the user application 30 to control a process of authentication for a transaction with the financial system 22. In one embodiment, the processor 58, executing the user application 30, may store a user key 400 (shown in FIG. 9A) in the memory 66.

In some embodiments, the memory 66 may be located in the same physical location as the user system 14, and/or one or more memory 66 may be located remotely from the user system 14. For example, the memory 66 may be located remotely from the user system 14 and communicate with the processor 58 via the network 26. Additionally, when more than one memory 66 is used, a first memory 66 may be located in the same physical location as the processor 58, and additional memory 66 may be located in a location physically remote from the processor 58. Additionally, the memory 66 may be implemented as a “cloud” non-transitory processor-readable medium (i.e., one or more memory 66 may be partially or completely based on or accessed using the network 26).

The input device 50 may be capable of receiving information input from the user and/or processor 58, and of transmitting such information to other components of the user system 14 and/or to (a device on) the network 26. The input device 50 may include, but is not limited to, implementation as a keyboard, a touchscreen, a mouse, a trackball, a smart card reader, a microphone, a camera, a fingerprint reader, an infrared port, an optical port/sensor, a cell phone, a smart phone, a PDA, a fax machine, a wearable communication device, a network interface, combinations thereof, and/or the like, for example.

The output device 54 may be capable of outputting information in a form perceivable by the user and/or processor 58. Implementations of the output device 54 may include one or more of, but are not limited to, a computer monitor, a screen, a smart card reader/writer, a touchscreen, a speaker, a website, a television set, a smart phone, a PDA, a cell phone, a fax machine, a printer, a laptop computer, a haptic feedback generator, an olfactory generator, a network interface, combinations thereof, and/or the like, for example.

It is to be understood that in some exemplary embodiments, the input device 50 and the output device 54 may be implemented as a single device, such as, for example, a touchscreen of a computer, a tablet, a smartphone, or a network interface. It is to be further understood that as used herein the term user is not limited to a human being, and may comprise a computer, a server, a website, a processor, a network interface, a user terminal, a virtual computer, combinations thereof, and/or the like, for example.

The processor 58 may be implemented as a single processor or multiple processors working together, or independently, to execute the user application 30 as described herein. It is to be understood, that in certain embodiments using more than one processor 58, the processors 58 may be located remotely from one another, located in the same location, or may comprise a unitary multi-core processor. The processors 58 may be capable of reading and/or executing processor-executable code, or instructions, and/or may be capable of creating, manipulating, retrieving, altering, and/or storing data structures into the memory 66 such as in the database 70.

Exemplary embodiments of the processor 58 may include, but are not limited to, a digital signal processor (DSP), a central processing unit (CPU), a graphical processing unit (GPU), a neural processing unit (NPU), a tensor processing unit (TPU), a field programmable gate array (FPGA), a microprocessor, a multi-core processor, an application specific integrated circuit (ASIC), combinations thereof, and/or the like, for example. The processor 58 may be capable of communicating with the memory 66 via the path 74 (e.g., data bus). The processor 58 may be capable of communicating with the input device 50 and/or the output device 54. The processor 58 may include one or more processor 58 working together, or independently, and located locally, or remotely, e.g., accessible via the network 26.

The processor 58 may be further capable of interfacing and/or communicating with the financial system 22 via the network 26 using the communication device 62. For example, the processor 58 may be capable of communicating via the network 26 by exchanging signals (e.g., analog, digital, optical, and/or the like) via one or more port (e.g., physical, or virtual ports) using a network protocol to provide updated information to the user application 30 or to the financial system 22.

In one embodiment, the database 70 may be a time-series database, a relational database, a vector database, or a non-relational database. Examples of such databases include DB2®, Microsoft® Access, Microsoft® SQL Server, Oracle®, mySQL, PostgreSQL, MongoDB, Apache Cassandra, InfluxDB, Prometheus, Redis, Elasticsearch, TimescaleDB, Chroma, Pinecone, Weaviate, and/or the like. It should be understood that these examples have been provided for the purposes of illustration only and should not be construed as limiting the presently disclosed inventive concepts. The database 70 may be centralized or distributed across multiple systems.

In one embodiment, the database 70 may be a centralized database with a distributed backup database, a distributed database with a centralized backup database, a distributed database with a distributed backup database, or a centralized database with a centralized backup database. In one embodiment, the database 70 abides by, or exceeds, the 3-2-1 backup best practices. In one embodiment, each backup database is maintained as a real-time backup database, e.g., the backup database may be a mirror of the database 70.

Referring now to FIG. 3, shown therein is a diagram of an exemplary embodiment of the financial system 22 constructed in accordance with the present disclosure. The financial system 22 may include one or more device that execute(s) one or more application in a manner described herein. In the illustrated embodiment, the financial system 22 is provided with a memory 82 (hereinafter “memory 82”) accessible by one or more processor 86 (hereinafter “processor 86”). The memory 82 may include one or more non-transitory computer-readable medium storing processor-executable code and/or finance application(s) 90 (hereinafter “finance application 90”). The memory 82 may further store (e.g., in the database 94) a user account associated to the user.

In some embodiments, the financial system 22 may comprise the one or more processor 86 working together or independently to execute processor-executable code, such as the finance application 90, stored on the memory 82. Additionally, the financial system 22 may include at least one input device 96 (hereinafter “input device 96”) and at least one output device 100 (hereinafter “output device 100”). Each element of the financial system 22 may be partially or completely network-based or cloud-based, and may or may not be located in a single physical location.

The processor 86 may be implemented as a single processor or multiple processors working together, or independently, to execute the finance application 90 as described herein. It is to be understood, that in certain embodiments using more than one processor 86, the processors 86 may be located remotely from one another, located in the same location, or comprising a unitary multi-core processor. The processors 86 may be capable of reading and/or executing processor-executable code and/or capable of creating, manipulating, retrieving, altering, and/or storing data structures into the memory 82 such as in a database 94.

Exemplary embodiments of the processor 86 may be constructed similar to and in accordance with the processor 58 described above in more detail. The processor 86 may be capable of communicating with the memory 82 via a path 104 (e.g., data bus). The processor 86 may be capable of communicating with the input device 96 and/or the output device 100.

The processor 86 may be further capable of interfacing and/or communicating with the financial system 22 via the network 26 using a communication device 108. For example, the processor 86 may be capable of communicating via the network 26 by exchanging signals (e.g., analog, digital, optical, and/or the like) via one or more port (e.g., physical, or virtual ports) using a network protocol to provide updated information to the user application 30 and to the finance application 90 (e.g., operable to provide the user interface) executed on the user system 14.

The memory 82 may store processor-executable code and/or information comprising the finance application 90. In some embodiments, the finance application 90 may be stored as a compiled application file, such as an executable file, for example, or in a structure (or unstructured) format, such as, e.g., in a non-compiled file. The finance application 90 may include, for example, a web browser capable of accessing a website and/or communicating information and/or data over a wireless or wired network (e.g., the network 26), and/or the like. In one embodiment, the processor 86, executing the finance application 90, may store a finance key 404 (shown in FIG. 9B) in the memory 82.

The input device 96 of the financial system 22 may transmit data to the processor 86 and may be constructed in accordance with or similar to the input device 50 of the user system 14 described above in more detail. The input device 96 may be located in the same physical location as the processor 86, or located remotely and/or partially or completely network-based. The output device 100 of the financial system 22 may transmit information from the processor 86 to the user, and may be similar to the output device 54 of the user system 14. The output device 100 may be located with the processor 86, or located remotely and/or partially or completely network-based.

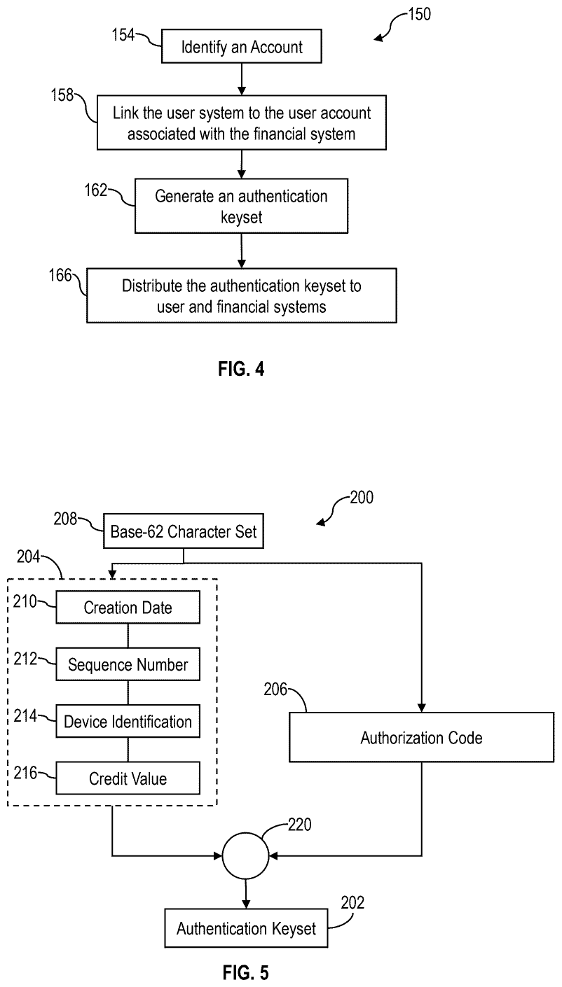

Referring now to FIG. 4, shown therein is a flow diagram of an exemplary embodiment of an institution process 150 constructed in accordance with the present disclosure. The institution process 150 generally comprises the steps of: identifying an account (step 154); linking the user system to the user account (step 158); generating an authentication keyset (step 162); and distributing the authentication keyset to user and financial systems (step 166).

In one embodiment, identifying an account (step 154) institutes a relationship between the user system 14 operated by the user (i.e., account holder) and the financial system 22, e.g., via the network 26. In one embodiment, identifying the account (step 154) may include the processor 58 comparing account identification information stored in the memory 66 (such as in the database 70) to account identification information received from the input device 96 to determine whether the received account identification information matches the account identification information stored on the financial system 22 in the memory 82.

In one embodiment, identifying an account (step 154) may further include establishing a line of credit identified by the account holder's name and an assigned primary account number such that both the user system 14 and the financial system 22 contain the account identification information. The assigned primary account number may be, for example, a credit card. In some embodiments, multiple credit cards may be associated with the assigned primary account number, such that the user may utilize multiple credit cards for the same account.

In one embodiment, linking the user system to the user account (step 158) includes determining ownership of the user system 14. Linking the user system to the user account may include, for example, the processor 58 passing a unique system identifier to the financial system 22 and the processor 86 receiving the unique system identifier and comparing the unique system identifier against a stored unique system identifier associated with the user account. In one embodiment, the unique system identifier may be, for example, a Machine Name of the user system 14, a UUID, a GUID, a MAC address, and/or the like.

In one embodiment, linking the user system to the user account (step 158) includes the processor 58 receiving one or more input from the user via the user interface 32 of the user application 30 and communicating, via the network 26, the one or more input from the user to the processor 86 of the financial system 22.

In one embodiment, linking the user system to the user account (step 158) occurs before initiation of a financial action, e.g., prior to a vendor submitting a purchase request (step 464 of activation process 450).

In one embodiment, linking the user system to the user account (step 158) includes the processor 86 validating that the user system 14 is unique to the user account and may assign a Device Identification Code (DIDC) to the user system 14. The processor 86 may then store the DIDC in the memory 82 such as in the database 94 and may associate the user account with the stored DIDC. In some embodiments, the processor 86 may then transmit the DIDC to the user system 14, such that the processor 58 may store the DIDC in the memory 66, for example, as the unique system identifier.

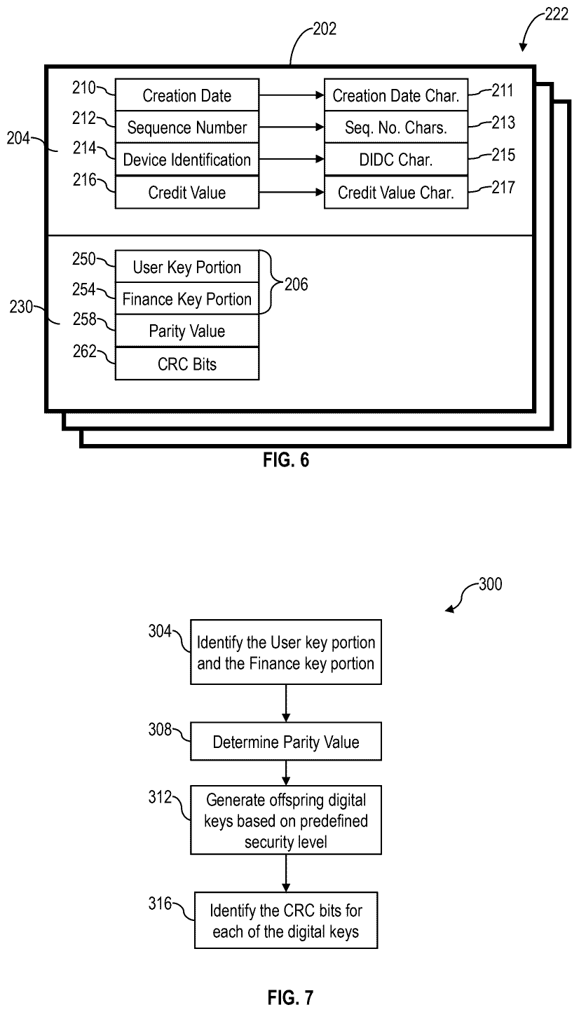

In one embodiment, generating the authentication keyset (step 162) includes the processor 58 generating a plurality of authentication keysets 202 as a keyset book 222 (as shown in FIGS. 5-6). In one embodiment, generating the authentication keyset 202 may be initiated, for example, by the user via the user interface 32 of the user application 30, thereby causing the processor 58 to generate a set of digital keys (e.g., the keyset book 222 comprising the plurality of authentication keysets 202 based on an authorization code 206), for example, by utilizing a keyset creation process 300 (described below and shown in FIG. 7). In some embodiments, the user, via the user interface 32, may indicate a number of the plurality of authentication keysets 202 to generate and include in the keyset book 222. In other embodiments, a predetermined number of the plurality of authentication keysets 202 may be generated and included in the keyset book 222.

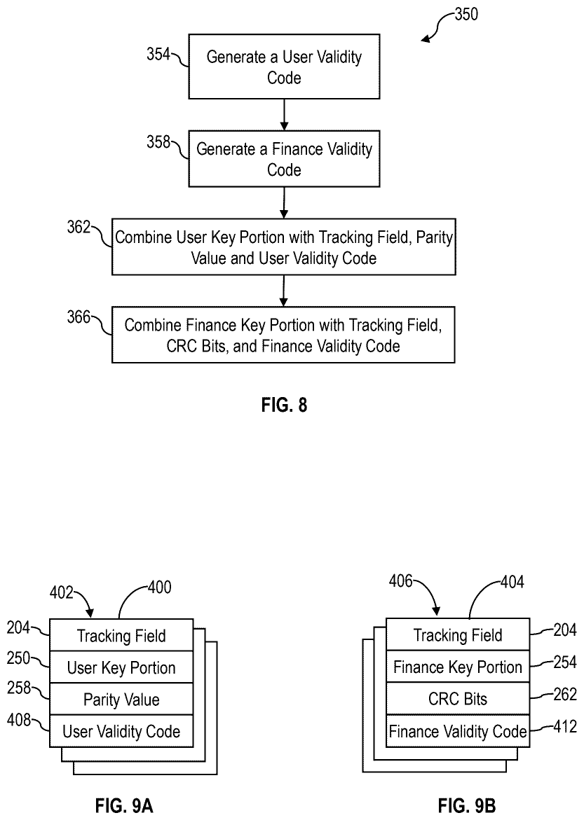

In one embodiment, the processor 58 may then fragment the authorization code 206 of the authentication keyset 202 to create unique keys having the user key portion 250 and the finance key portion 254 (as described below in relation to key decomposition process 350 and shown in FIG. 8). The user key portion 250 may be, for example, a unique most significant bit segment (i.e., left portion or half) of an authorization code 206 and the finance key portion 254 may be, for example, a unique least significant bit segment (i.e., a right portion or half) of an authorization code 206.

In one embodiment, distributing the authentication keyset (step 166) includes the processor 58 storing the user key portion 250 (as part of the user key 400, for example) in the memory 66, such as in the database 70 for example. In one embodiment, the processor 58 may store the user key portion 250 in a secure memory, such as a secure portion of the memory 66 or in a second memory 66 that is at least encrypted at rest. In one embodiment, distributing the authentication keyset (step 166) further includes the processor 58 temporarily storing the finance key portion 254 in the memory 66 (or the secure memory), such as in the database 70, for example in preparation for distributing the finance key portion 254 to the financial system 22.

In one embodiment, distributing the authentication keyset (step 166) may further include the processor 58 transmitting the finance key portion 254 (as part of the finance key 404, for example) to the financial system 22, e.g., via the network 26. The processor 58, via the communication device 62 may first establish a secure connection with the communication device 108 of the financial system 22, such as via an encrypted connection. The processor 58 may cause the processor 86 to store the finance key portion 254 (e.g., as the finance key 404) in the memory 82, such as in the database 94 or in a secure memory, for example. The processor 86 may store the finance key portion 254 in the memory 82 and may associate the finance key portion 254 with the user account, account identification information, and/or with the DIDC, for example. In other embodiments, the processor 58, via the communication device 62, may first establish an insecure connection with the communication device 108 of the financial system 22, e.g., as a network connection via the network 26.

In one embodiment, distributing the authentication keyset 202 (step 166) further includes the processor 58 storing multiple user key portions 250 (e.g., as part of a user key book comprising a plurality of the user keys 400 having similar tracking fields 204 as described below) in the memory 66, or secure memory, such as in the database 70 for example, and further includes the processor 58 transmitting the finance key portion 254 (e.g., as part of a finance key book comprising a plurality of the finance key 404 having the same tracking fields 204 as the user key book) to the financial system 22, e.g., via the network 26.

In this way, by distributing the authentication keyset separately, a private key (which must traditionally be protected) is not required to ensure the financial transaction is secure.

In one embodiment, generating the authentication keyset (step 162) may be performed before initiation of a financial action, e.g., prior to a vendor submitting a purchase request (step 464 of activation process 450).

The institution process 150 provides the technical solution of increasing financial transaction security to the technical problem of the poor transaction security of traditional systems by linking the user account under the financial system 22 to the user system 14 (e.g. via step 158) then further strengthening the linkage by distributing the user key 400 (or user keyset book 402) and the finance key 404 (or finance key book 406) of the authentication keyset 202 (or keyset book 222) uniquely between the user system 14 and the financial system 22 (e.g., via step 166). In this way, the institution process 150 establishes ownership of the account identification information and ties the transaction request directly back to the user account of the user on the user device 14. It should be understood that this two-level identification provided by the institution process 150 establishes a relationship between the account holder (e.g., user) and the account holder's account (e.g., user account) at the financial system 22 and, in some embodiments, does not authenticate the transaction request, as the institution process 150 only establishes the relationship and identity between user system 14 and financial system 22. Once this relationship is established, the transaction request can be authenticated using a reconstitution and validation process 500, for example.

Referring now to FIG. 5, shown therein is a diagram of an exemplary embodiment of an authentication keyset construction diagram 200 constructed in accordance with the present disclosure. Generally, the processor 58 receives one or more input from the user, via the user interface 32 and the input device 50, indicative of an instruction to generate each authentication keys 202 of the keyset book 222. The processor 58 may generate each authentication keyset 202 based at least in part on the authorization code 206 and a tracking field 204. In one embodiment, the authorization code 206 has a value (for example only, “7xpQLtVJMys40gD691iqU11qaWwnNxBa”) that is a randomly generated string of characters, for example, a string of characters randomly selected from an encoding character set 208, such as a base-62 character set including an index of the digits for 0-9, the capital letters A-Z, and the lower-case letters a-z. In some embodiments, the string of characters may have a predetermined length, such as 32, 64, 128, 256, 512, or 1024 characters for example, although other numbers of characters may also be utilized.

In one embodiment, to track the authentication keyset 202, the processor 58 generates the tracking field 204 based at least in part on particular information of the account identification information such as, for example, a creation date 210, a key sequence number 212, a DIDC 214, and a credit value 216. In one embodiment, the tracking field 204 may be encoded using the encoding character set 208 and may comprise a second predetermined number of characters. For example, the tracking field 204 may comprise five (5) characters, e.g., “E03DC”. In one embodiment, the tracking field 204 is combined (at combination 220) with the authorization code 206 to form a particular authentication keyset 202 as detailed in FIG. 6. In one embodiment, multiple authentication keyset 202 are generated having similar tracking fields 204 (except differing key sequence numbers 212 and/or credit values 216) as part of a keyset book 222.

Referring now to FIG. 6, shown therein is a data diagram of an exemplary embodiment of a keyset book 222 comprising a plurality of the authentication keyset 202 constructed in accordance with the present disclosure. The authentication keys 202 generally comprise the tracking field 204 combined with internal key data 230 and may be constructed, for example, using the authentication key creation process 300 (described below and shown in FIG. 7).

As discussed above, the tracking field 204 may comprise four attributes, such as the creation date 210, the key sequence number 212, the DIDC 214, and the Credit Value 216. In some embodiments, the tracking field 204 may contain features selected by the user (via the user interface 32 of the user application 30 executed on the user system 14) to manage credit risk applied during the financial transaction by limiting the amount of credit released by each transaction and limiting the number of possible transactions assigned to the user system 14.

In one embodiment, the creation date 210 may be defined by a creation date value 211 (e.g., a single character) to add variability to the tracking field. In one embodiment, the key sequence number 212 may be defined by two unique sequence number characters 213 in order to ensure each authentication keyset 202 within the keyset book 222 has a non-repeating tracking field 204. In one embodiment, the DIDC 214 is defined by a single Device Identification Character 215 which establishes ownership of the user system 14 to the user account through the commonly associated DIDC as described above. In one embodiment, the Credit Value 216 is defined by a single credit value character 217. The Credit Value 216 may be selected by the user via the user interface 32 of the user system 14 during creation of the authentication keyset 202 to limit an amount of credit at risk when the authentication keyset 202 is activated during the transaction process.

In one embodiment, the creation date value 211, the sequence numbers characters 213, the DIDC character 215, and the credit value character 217 may include characters from a defined set of alphanumerical characters to represent possible data from the transaction process, such as characters from the encoding character set 208. For example, the creation date value 211 may include the capital letters A-Z for dates 1-26 and the lower-case letters a-e for dates 27-31, such that the tracking field 204 example of “E03DC” indicates that the authentication key was created on the 5th day of the month (the ‘E’ character) as the third key (the “03” numbers) for the user system 14 having the DIDC character “D” for a maximum credit value of $10 (the “C” character).

In one embodiment, the single credit value character 217 may include a character from the encoding character set 208 corresponding to a predetermined value, for example, the “C” character may correspond to $10, while a “T” character may correspond to a $10,000 value. In some embodiments, at least one character from the encoding character set 208 corresponds to an “undefined” value, such as, an open-ended value, or in other embodiments, a zero (0) value. In some embodiments, the single credit value character 217 may be case-sensitive, e.g., “A” is different from “a,” while in other embodiments, the single credit value character 217 may be case-insensitive, e.g., “A” is the same as “a.” In some embodiments, the single credit value character 217 may be one character of a subset of characters selected from the encoding character set 208. For example, the subset may be capitalized alphabet characters, A-Z, or may be lower-case alphabet characters, a-z. In one embodiment, the credit value character may represent a credit limit value as established in an array of characters A-Z where character “A” allows for an unrestricted credit use and characters B-Z represent increasing credit limit values from $5 to $100,000, as an example.

As shown in FIG. 6, the internal key data 230 embeds the authorization code 206 and encodes rules to segregate and re-assemble the authentication keysets 202 of the keyset book 222. As shown, in one embodiment, the authorization code 206 may be split into two equal parts that form the user key portion 250 (e.g., the key's Most Significant Bits (MSB)) and the finance key portion 254 (e.g., the key's Least Significant Bits (LSB)). The user key portion 250 may comprise a first half of the authorization code 206 and the finance key portion 254 may comprise a second half of the authorization code 206. For example, if the authorization code 206 has a predetermined length of 32 characters, the user key portion 250 may comprise the leftmost 16 characters of the authorization code 206 (for example, “7xpQLtVJMys40gD6”) and the finance key portion 254 may comprise the rightmost 16 characters of the authorization code 206 (for example, “91iqU11qaWwnNxBa”). In other embodiments, the user key portion 250 may be the key's LSB, while the finance key portion 254 may be the key's MSB. While generating the user key portion 250 and the finance key portion 254 is described as splitting the authorization code 206 in “half” or into “two equal parts.” it should be understood that, in some embodiments, splitting the authorization code 206 may include providing a first portion of the authorization code 206 as the user key portion 250 and a second portion of the authorization code 206 as the finance key portion 254 where there first portion and the second portion have differing lengths (e.g., a differing number of characters of the authorization code 206).

In one embodiment, the segregate and re-assemble rules are defined by two randomly selected characters from the encoding character set 208 and form a parity value 258. The index value from each of the Parity Value characters of the parity value 258, in combination with a set of business rules, uniquely define how the authorization code 206 is mutated to secure information within the authentication keysets 202 of the keyset book 222.

In one embodiment, CRC bits 262 of the internal key data 230 contain numerous sets of Cyclic Redundancy Check (CRC) binary values generated by the set of business rules as defined by the parity value 258.

In this way, the authentication system 10 provides the technical solution of achieving strong security of the authentication for a financial transaction by the decomposition of the authorization code 206 into separate units that are distributed separately and only united at one time during transaction authentication (e.g., as described in reconstitution and validation process 500 described below and shown in FIG. 11), such that each separate portion, by itself, cannot be used to reconstruct the other portion, as described in more detail below in relation to FIG. 8.

Referring now to FIG. 7, shown therein is a process flow diagram of an exemplary embodiment of the keyset creation process 300 constructed in accordance with the present disclosure. The keyset creation process 300 is utilized to construct the authentication keyset 202 as detailed in FIG. 6 and discussed above. Generally, the keyset creation process 300 comprises the steps of: identifying the user key portion and the finance key portion (step 304); determining the parity value (step 308); generating offspring digital keys based on a predefined security level (step 312); and identifying the CRC bits for each of the digital keys (step 316).

In one embodiment, identifying the user key portion and the finance key portion (step 304) includes partitioning the authorization code 206 into the user key portion 250 and the finance key portion 254. The user key portion 250 may comprise of the first half of the authorization code 206 and the finance key portion 254 may comprise of the second half of the authorization code 206. As detailed above, the user key portion 250 may be the Most Significant Bit (MSB) of the authorization code 206, and the finance key portion 254 may be the Least Significant Bit (LSB) of the authorization code 206. In the example provided above, the authorization code 206 may have the value of “7xpQLtVJMys40gD691iqU11qaWwnNxBa” such that the MSB of the authorization code 206, i.e., the user key portion 250, is “7xpQLtVJMys40gD6” and the LSB of the authorization code 206, i.e., the finance key portion 254, is “91iqU11qaWwnNxBa”.

In one embodiment, determining the parity value (step 308) includes determining two randomly selected characters from the encoding character set 208, such as two randomly generated Base-62 Characters, for example, as the parity value 258. For example only, consider if the parity value 258 includes the character set “vN” from the encoding character set 208. The parity value 258 is thus used to define business rules to establish various levels of internal key security of the authentication keyset 202. Each character of the parity value 258 is converted to an equivalent character set index value, e.g., if the encoding character set 208 is the Base-62 Character Set, then the character set index value may be defined as the first character “v” having an index of 57 and the second character “N” having an index of 23. In this way, for a two-level internal key security, the first character of the parity value 258 defines Level 1 key security and the second character of the parity value 258 defines Level 2 key security. In some embodiments, the characters in the encoding character set 208 are case-sensitive.

In one embodiment, generating offspring digital keys based on a predefined security level (step 312) includes mutating the authorization code 206 based on the parity value 258 to generate the offspring digital keys. For example, the authorization code 206 may be mutated through two-character rotations based on the applied security level of the parity value 258 of “vN”. Each of the offspring digital keys may correspond to a particular one of the user key portion 250 and the finance key portion 254. For example, a level 1 offspring digital key may be generated from the authorization code 206 (or the user key portion 254 and the finance key portion 254) by incrementing each character of the authorization code 206 by the first character (e.g., “v”), and a level 2 offspring digital key may be generated from the authorization code 206 (or the user key portion 250 and the finance key portion 254) by (further) incrementing each character of the authorization code 206 by the second character (e.g., “N”). In some embodiments, the applied security level may be adjusted by changing the parity value 258.

In one embodiment, the level 2 offspring digital key may be derived either directly from the authorization code 206 or may be derived from the resulting level 1 offspring digital key.

In one embodiment, incrementing each character may include determining an index of each character in the encoding character set 208 and summing the index for each character in the authorization code 206 by the index of the first character of the parity value 258. For example, considering the encoding character set 208 is the Base-62 character set, a character “E” of the authorization code 206 has an index value of “14” and “v” (the first character of the parity value 258) has an index value of “57”, so incrementing “E” by “v” may include summing 14+57 to get a summation value of 71. However, an index of 71 is not provided in Base-62. In some embodiments, incrementing each character may further include circular array indexing or array wrapping, such that, when the summed index exceeds the length of the encoding character set 208, the summed index subtracts the length of the encoding character set 208 to determine the summed index. In the example of the summed index being 71, then, the length of the base-62 character set (i.e., 62) may be subtracted from the summed index (or by use of a modulo operator/function), resulting in a summed index of 9, which corresponds to a ‘9’ character in the encoding character set 208. In this way, the level 1 offspring key may be generated having a level 1 user key portion 250 and a level 1 finance key portion 254. In the example authorization code 206, then the level 1 user key portion 250 may be “2skLGoQEHtnzvb81” and the level 1 finance key portion 254 may be “4gd1Pwwl5Rrils6V”.

In one embodiment, incrementing each character of the level 1 offspring key may include determining an index of each character of the level 1 user key portion 250 and the level 1 finance key portion 254 in the encoding character set 208 and summing the index for each character in the authorization code 206 by the index of the second character of the parity value 258, e.g., the level 2 character. In this way, the level 2 offspring key has a level 2 user key portion 250 and a level 2 finance key portion 254. In the example authorization code 206, where the level 1 user key portion 250 is “2skLGoQEHtnzvb81” and the level 1 finance key portion 254 is “4gd1Pwwl5Rrils6V”, then the level 2 user key portion 250 may be “PF7idBnbeGAMlyVO” and the level 2 finance key portion 254 may be “R308mJJ8SoE5fFTs”.

In one embodiment, identifying the CRC bits for each of the keys (step 316) includes capturing characteristics of the authorization code 206 and each of the two additional levels of user key portion 250 and the two additional levels of finance key portions 254. In one embodiment, the CRC bits 262 are computed from a binary XOR operation between a binary polynomial and a binary conversion of each of the offspring digital keys. In one embodiment, the binary polynomial is constructed from the creation date value 211 and the sequence number characters 213 converted into a 16-bit integer where the most significant bit and the least significant bit of the 16-bit integer are set to “1” to ensure the binary polynomial order takes the form of “X16+ . . . +1”. A remainder of the binary XOR operation between the binary polynomial and a particular digital key results in a 4-character set composed of hexadecimal characters. For example, if the authorization code CRC bits 262 are “3f28”, then Level 1 CRC bits 262 are “319d” and the Level 2 CRC bits 262 are “1d7d” resulting in CRC bits 262 “3f28319d1d7d”, e.g., the concatenation of the CRC bits 262 from the authorization code 206, the level 1 CRC bits 262 and the level 2 CRC bits 262. In other embodiments, additional levels of internal key security may be provided by incorporating new business rules upon the parity value 258 and including the added CRC bits 262 for each advanced level, ensuring higher degrees of protection as needed by the credit industry. In some embodiments, the CRC bits 262 may be computer utilizing a method other than the binary polynomial to increase encryption complexity.

Referring now to FIG. 8, shown therein is a process flow diagram of an exemplary embodiment of a keyset decomposition process 350 constructed in accordance with the present disclosure. The keyset decomposition process 350 is utilized to decompose the authorization code 206 into the user key 400 and the finance key 404 as shown in FIGS. 9A-B. Generally, the keyset decomposition process 350 comprises the steps of: generating a user validity code (step 354); generating a finance validity code (step 358); combining the user key portion 250 with the user validity code 408, the tracking field 204, and the parity value 258 (step 362); combining the finance key portion 254 with the finance validity code 412, the tracking field 402, and the CRC bits 262 (step 366). In one embodiment, the processing component 58 may perform the keyset decomposition process 350 for each authentication keyset 202 of a keyset book 222 to generate the user key book 402 and the finance key book 406.

In one embodiment, generating the user validity code 408 (step 354) includes prefixing the user key portion 250 with the tracking field 204 and suffixing the user key portion 250 with the parity value 258. Continuing from the above example, the user key portion 250 of “7xpQLtVJMys40gD6” may be prefixed with the tracking field 204 of “E03DC” and the parity value 258 of “vN” resulting in “E03DC7xpQLtVJMys40gD6vN”. A user validity code 408 may be determined by summing ASCII code values for each of the characters of the combined user key portion 250, the tracking field 204, and the parity value 258, and converting that summation into a two-character string based on the encoding character set 208. For example, summing ASCII code values for each of the characters of the combined user key portion 250, the tracking field 204, and the parity value 258 and converting that summation into a two-character string may result in the user validity code 408 being “Tx”. Continuing the example above, concatenating user validity code 408 “Tx” to the end of “E03DC7xpQLtVJMys40gD6vN” results in the user key 400 being “E03DC7xpQLtVJMys40gD6vNTx”, for example. In one embodiment, the processor 58 may store the user key 400 in the memory 66, such as in the database 70, for example.

In one embodiment, generating the finance validity code 412 (step 358) includes prefixing the finance key portion 254 with the tracking field 204 and suffixing the finance key portion 254 with the CRC bits 262. Continuing from the above example, the finance key portion 254 of “91iqU11qaWwnNxBa” may be prefixed with the tracking field 204 of “E03DC” and the CRC bits 262 of “3f28319d1d7d” resulting in “E03DC91iqU11qaWwnNxBa3f28319d1d7d”. A finance validity code 412 may be determined by summing ASCII code values for each of the characters of the combined finance key portion 254, the tracking field 204, and the CRC bits 262, and converting that summation into a two-character string based on the encoding character set 208. For example, summing ASCII code values for each of the characters of the combined finance key portion 254, the tracking field 204, and the CRC bits 262 and converting that summation into a two-character string may result in the finance validity code 412 being “eb”. Continuing the example above, concatenating the finance validity code 412 being “eb” to the end of “E03DC91iqU11qaWwnNxBa3f28319d1d7d” results in the finance key 404 being “E03DC91iqU11qaWwnNxBa3f28319d1d7deb”, for example. In one embodiment, the processor 86 may store the finance key 404 in the memory 82, such as in the database 94, for example.

In one embodiment, generating the finance validity code (step 358) further includes first encrypting the combined finance key portion 254 and the CRC bits 262. In one embodiment, encrypting the finance key 404 may include using the user key portion 250 to encrypt the finance key portion 254 and the CRC bits 262 of the finance key 404. The tracking field 204 remains unencrypted to allow keyset matching during the reconstitution and validation process 500. Continuing with the example above, the combined finance key portion 254, the tracking field 204, and the CRC bits 262 being “E03DC91iqU11qaWwnNxBa3f28319d1d7d” and encrypted with the user key portion 250 being “7xpQLtVJMys40gD6” may result in an encrypted combination being “E03DCCOkyX2ATBj30QcDie4bf4aa74a8e”. The finance validity code 412 may then be determined by summing ASCII code values for each of the characters of the encrypted combination and converting that summation into a two-character string based on the encrypting character set 208.

Referring now to FIGS. 9A-B, in combination, shown therein are block diagrams of exemplary embodiments of user key book 402 comprising a plurality of the user key 400 and the finance key book 406 comprising a plurality of the finance key 404, respectively, constructed in accordance with the present disclosure. In this way, each authentication keyset 202 of the keyset book 222 is decomposed via the keyset decomposition process 350 into two parts: the user key 400 shown in FIG. 9A and the finance key 404 shown in FIG. 9B, which, when separated (e.g., when stored on different system or different memories), protect the authorization code 206 and, when collected, provide a secure means of authentication.

As shown, the user key 400 may be constructed as a concatenation of the tracking field 204 (used to identify key halves), the user key portion 250 (e.g., the first half of the authorization code 206), the parity value 258 (used to define the rules of decomposition and reconstitution of the key), and the user validity code 408 (used to perform an external check of integrity of the user key 400), while the finance key 404 may be constructed as a concatenation of the tracking field 204 (used to identify key halves), the finance key portion 254 (e.g., the second half of the authorization code 206), the CRC bits 262 (used to capture the characteristics of the internal key data), and the finance validity code 412 (which is used to perform an external check of the integrity of the finance key 404).

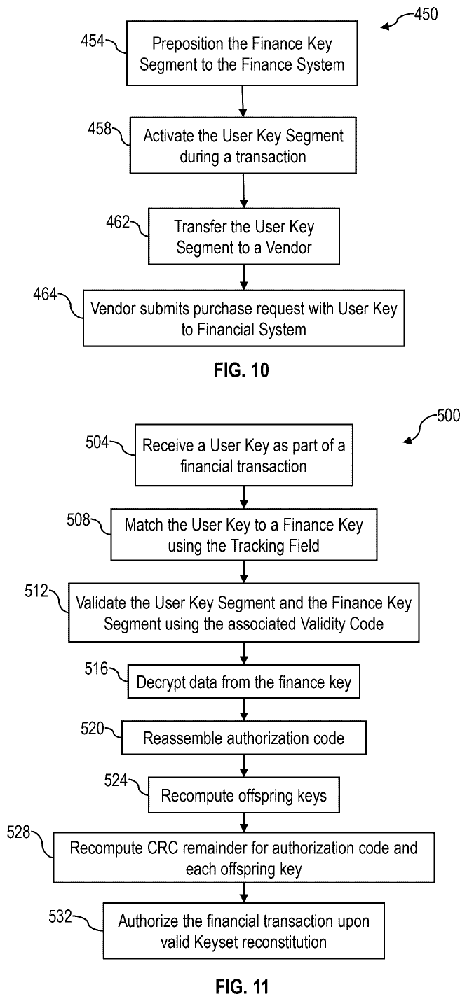

Referring now to FIG. 10, shown therein is process flow diagram of an exemplary embodiment of an activation process 450 constructed in accordance with the present disclosure. The activation process 450 generally comprises the steps of: prepositioning the finance key to the finance system (step 454); activating the user key during a transaction (step 458); and transferring the user key to a vendor (step 462); and having the vendor submit a purchase request having the user key 400 to the financial system 22 (Step 464).

In one embodiment, prepositioning the finance key to the finance system (step 454) may include the processor 58 retrieving the finance key 404 from the memory 66, such as from the database 70, and providing the finance key 404 to the financial system 22, e.g., via the network 26. This step may be performed by the processor 58 prior to a financial transaction. At completion of the transfer of the finance keys 404 (or finance key book 406) to the financial system 22, the processor 58 may expunge, delete, or otherwise remove, the finance key book 406 from the memory 66, such as from the database 70, thereby ensuring the only means of key authentication can only be accomplished by the collaborating financial system 22.

In one embodiment, activating the user key (step 458) includes initiation of a financial transaction by the user via the user system 14.

In one embodiment, transferring the user key 400 to a vendor (step 462) includes the processor 58 selecting the activated user key (such as from the memory 66) and transmitting the activated user key to a vendor as part of the financial transaction. The vendor may then process the financial transaction with the activated user key through the financial system 22 for authentication.

In one embodiment, transferring the user key 400 to a vendor 640 (step 462) includes the processor 58 selecting the activated user key 400 and transmitting the activated user key 400 to a second user as part of the financial transaction. The second user may receive the user key 400 via a second user system and process the financial transaction with the activated user key 400 through the financial system 22 for authentication. In other words, the vendor 640 may not be a merchant, but may be another user such that the user key 400 may be utilized as part of a credit transfer between users.

In one embodiment, transferring the user key 400 to a vendor 640 (step 462) includes the processor 58 activating the user key 400 to provide the user key portion 250 as part of a transaction request (having a transaction associated with a transaction user account) to the financial system 22. The vendor 640 may provide the user key 400 as part of the vendor's transaction request sent to the financial system 22. The processor 86 may use the user key 400 having the user key portion 250 and the finance key 404 having the finance key portion 254 associated with the transaction and the user account to reconstitute the authentication keyset 202, and validate the reconstituted authentication keyset 202 against the account information associated with the finance key 404 (e.g., the CRC bits 262 and/or the finance validity code 412) stored in the memory 82.

Referring now to FIG. 11, shown therein is a process flow diagram of an exemplary embodiment of the reconstitution and validation process 500 constructed in accordance with the present disclosure. The reconstitution and validation process 500 generally comprises the steps of: receiving a user key as part of a financial transaction (step 504); matching the user key 400 to a finance key 404 using the tracking field 204 (step 508); validating the user key 400 and the finance key 404 using the validity codes (step 512); decrypting data from the finance key 404 (step 516); reassembling authorization code 206 (step 520); recomputing offspring keys (step 524); recomputing CRC remainder for the authorization code 206 and each offspring key (step 528); and authorizing the financial transaction upon validation of the reconstituted keyset (step 532). Generally, the reconstitution and validation process 500 may be executed by the processor 86 of the financial system 22. Generally, if the processor 86 is unable to complete any step of the reconstitution and validation process 500, the financial transaction is rejected, canceled, or otherwise aborted.

In one embodiment, receiving a user key 400 as part of a financial transaction (step 504) includes the processor 86 receiving the user key 400 from the vendor 640, e.g., via the network 26.

In one embodiment, matching the user key 400 to a finance key 404 (step 508) includes selecting the tracking field 204 from the user key 400 and selecting a finance key 404 from the memory 82 (e.g., the database 94) having a matching tracking field 204. If no finance key 404 having a matching tracking field 204 is found, the financial transaction is rejected.

In some embodiments, such as if the user system 14 having the user keys 400 is lost and/or stolen, the associated finance keys 404 may be removed from the financial system 22. In this way, the user losing access to the user keys 400 does not expose the customer to risk of substantial credit loss as deletion of the finance keys 404 from the financial system 22 ensures that the lost user keys 400 cannot be utilized and, even if one or more of the user keys 400 is fraudulently used prior to deletion of the corresponding finance keys 404, the credit value 216 of the user keys 400 limits the user's exposure to credit losses exceeding the credit value 216. The user may then utilize a blank card (e.g., a new, blank, or unused user system 14) and initialize the institution process 150 to “reload” user keys 400 and finance keys 404 as described herein.

In one embodiment, validating the user key 400 and the finance key 404 (step 512) may include the processor 86 recomputes a user validity code 408 of the user key 400 and a finance validity code 412 of the finance key 404 (as described above in relation to steps 362 and 366, for example) and comparing the computed user validity code to the user validity code 408 of the user key 400 and the computed finance validity code to the finance validity code 412 of the finance key 404. If either of the computed user validity key or computed finance validity key fail to match the user validity code 408 or the finance validity code 412, respectively, then the financial transaction is rejected.

In one embodiment, decrypting data from the finance key (step 516) includes the processor 86 decrypting the finance key portion 254 of the finance key 404 using the user key portion 250 of the user key 400.

In one embodiment, reassembling authorization code 206 (step 520) may include the processor 86 recombining the finance key portion 254 of the finance key 404 (e.g., the decrypted finance key portion from step 516) and the user key portion 250 of the user key 400.

In one embodiment, recomputing offspring keys (step 524) may include the processor 86 extracting the parity value 258 from the user key 400 and recomputing the level 1 offspring key and the level 2 offspring key as described above in relation to step 312 of the keyset creation process 300.

In one embodiment, recomputing CRC remainder for the authorization code 206 and each offspring key (step 528) may performed by the processor 86 (as described above in relation to step 316 of the keyset creation process 300) and may include recreating the binary polynomial from the creation date value 211 and sequence number characters 213 of the tracking field 204 of either of the user key 400 or the finance key 404. The processor 86 may then translate each key (e.g., authorization code 206 and each of the level 1 and level 2 user key portion 250 and the level 1 and level 2 finance key portions 254) into a binary form suffixed with respective CRC bits 262 from the finance key 404. For each of the keys, a CRC remainder is recomputed by calculating a binary XOR operation between the binary polynomial and each respective key. In this way, if all of the CRC remainers for the keys are zero (0), then the authorization code 206 is determined to be valid. If the CRC remainder is not zero (0) for any of the keys, the financial transaction is rejected.

In one embodiment, authorizing the financial transaction (step 532) may be completed if the financial transaction has not been rejected in any prior step of the reconstitution and validation process 500.

In one embodiment, authorizing the financial transaction (step 532) may further include providing the user with an indication of a vendor 640 and/or amount of the financial transaction that has been authorized. Financial transaction properties, such as the vendor 640 and/or amount of the transaction (e.g., consumed credit) may be stored by the processing component 86 in the memory 82 or may be transmitted to the processing component 58 of the user system 14, thereby causing the processing component 58 to store the financial transaction properties in the memory 66 and/or to provide a notification, on the output device 54 of the user system 14, indicative of the authorized financial transaction and one or more of the financial transaction properties.

In one embodiment, authorizing the financial transaction (step 532) does not require that the user provide a PIN to the financial system 22. The user manages the authentication keyset book 222 using the user interface 32 to create and delete the authentication keyset(s) 202 as stored in the user system 14 where creation of a PIN to control access to the user system 14 may be managed by the user. No security code is required to be provided to the financial institute 650 as part of a transaction because the distributed authentication keyset 202 establishes the identity between the credit account and the user 608.

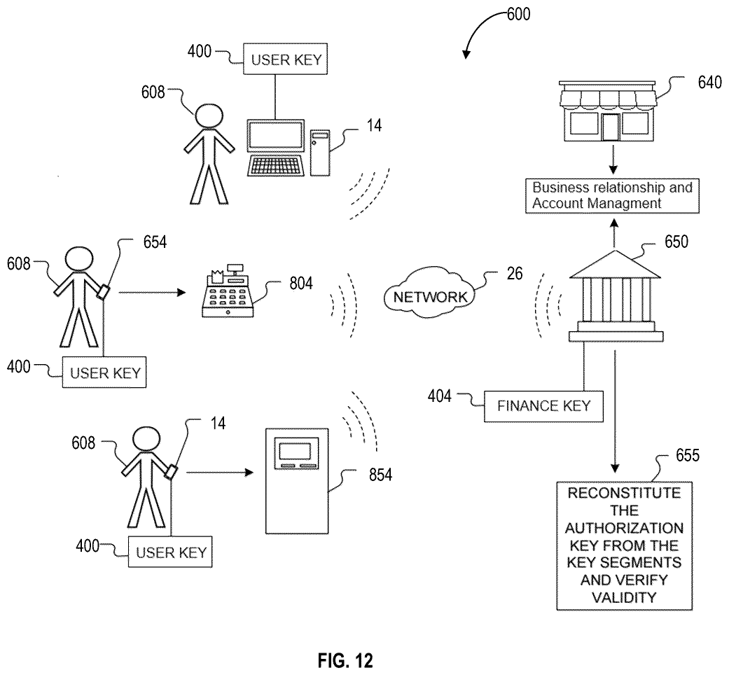

Referring now to FIG. 12, shown therein is a diagram of an exemplary embodiment of a credit exchange system 600 constructed in accordance with the present disclosure. As shown, the credit exchange system 600 uses the user key 400 and the finance key 404 to provide protection to a user 608, a financial institution 650 and a commercial entity 640 from fraudulent financial transactions. The user 608 is protected as the user 608 only exposes one user key 400 at a time that has a limited credit value 216 and because the user key 400 can only be used in a single financial transaction, once the user key 400 is consumed (e.g., used to authorize the financial transaction, such as in step 532 described above), the user's credit is no longer at risk. The commercial entity 640 is protected as the data retained after the financial transaction using the user key 400 is no longer actionable, thereby relieving the security risk of data at rest within the commercial entity's information system. The financial institution 650 is protected as the transaction process using the user key 400 ties the owner of the credit directly to the owner's user system 14 ensuring that the user 608 is made aware of the transaction request, which greatly reduces the risk of unknown fraudulent financial transactions.

Continuing to reference FIG. 12, the user 608 has control over management of access to credit using the financial credit system as constructed in accordance with the present disclosure. The user 608 may create, delete, and distribute the keyset book 222 using the user system 14. As described above, the user 608, utilizing the user application 30 on the user system 14, may create and/or distribute the user key book 402 into secure storage (such as on a secure memory of the one or more memory 66) on the user system 14 and a finance key book 406 to the financial system 22 of the financial institution 650. User 608 may set the credit value 216 for each authentication keyset 202 and may determine how many authentication keysets 202 to store on a given device, such as the user system 14, thus controlling and limiting the risk to the user's credit. The user 608 may completely remove access to their credit by deleting any unused finance keys 404 assigned to their credit account using the financial institution 650 web services for account management constructed in accordance with the present disclosure.

In some embodiments, the user 608 utilizing the user application 30 on the user system 14, may create and/or distribute the user key 400 into a secure storage (such as on a secure memory) of a hardware authentication device 654. In one embodiment, the user key 400 stored on the hardware authentication device 654 may only be altered with one or more external device such as the user system 14, the financial system 22, or an automatic teller machine application 854, for example. Once the authentication key segments are distributed, the user 608 may instigate a financial transaction using any of the user system 14 and the hardware authentication device 654 by exposing a user key 400 from the secure storage and submitting the user key 400 as part of the financial transaction request.

In one embodiment, the user 608 enters the credit exchange system 600 by opening a credit account with the financial institution 650 that is enabled to manage the segmented Authentication keysets 202. As described above in more detail, the user 608 may utilize the user application 30 to register the user system 14 (and/or the hardware authentication device 654) as a registered device with the financial system 22 and creates the keyset book 222 for each of the registered devices. Once the finance keys 404 are distributed to the financial system 22 and the user keys 400 are stored in each of the registered devices, the user 608 may conduct commerce with likewise enabled businesses.

In one embodiment, the financial institution 650 may institute an accounting system in accordance with the present disclosure. Each user 608 may be assigned to a credit account that persists even in the event of fraudulent action against the authentication keyset 202 because the credit account number is not associated with the fiscal action of credit approval. In this way, the user's financial assets are protected from additional fraudulent action without requiring cancellation and/or a “freeze” of the user's credit account number.

In one embodiment, the financial institution 650 manages the financial transaction through the network 26 to accomplish day-to-day activities. The transmission of finance keys 404 from the user device 14 to the financial institution 650 requires no specialized communication security because the finance key 404 itself provides no information that can be acted on to execute the exchange of credit. The transmission of the user key 400 from the user device 14 to the vendor 640 to be submitted to the financial institute 650 as part of the transaction request requires no specialized communication security as the user key 400 cannot be acted on outside of the financial institute 650 and once the user key 400 is authenticated with its paired finance key 404, the user key 400 is no longer usable. In one embodiment, the financial institution 650 may not be required to manage authentication keyset 202 or bear the security risk of storing both the user key 400 and the finance key 404 prior to the distribution of the authentication keyset book 222. The encoding process of the authentication keyset generation may be an open-source resource allowing all user devices 14 access to the keyset creation process 300 and the keyset decomposition process 350 to create the authentication keysets 202 independently of the financial institution 650. The security of the authentication keyset 202 is innate to its distributed structure not in the encryption method.

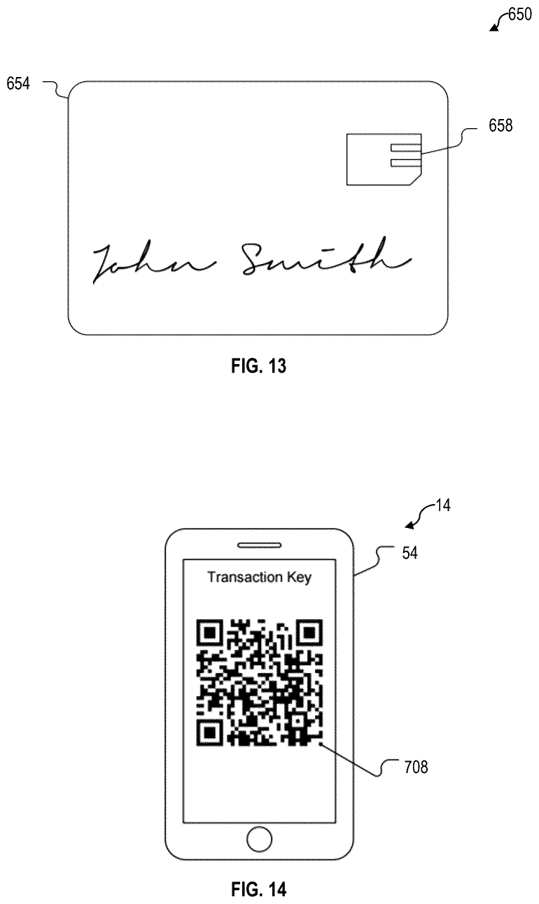

Referring now to FIG. 13, shown therein is an illustration of an exemplary embodiment of the hardware authentication device 654 constructed in accordance with the present disclosure. The hardware authentication device 654 may include, for example, a chip 658 (such as an EMV chip), or near field communication enabled smart card, that can store and retrieve the user keys 400 to/from a secure memory when interfacing with a point of sales terminal 804. The user 608, upon presenting the registered device to conduct a sale, allows the point of sale terminal 804 to inspect the user keys 400. If a user key 400 credit value 216 is greater than a transaction cost of the sale, then the financial transaction is allowed, otherwise the financial transaction is denied. In some embodiments, the chip 658 may be constructed as the user system 14.

Referring now to FIG. 14, shown therein is a diagram of an exemplary embodiment of the user system 14 constructed in accordance with the present disclosure. The user system 14 may be implemented as a near field communication (NFC) enabled hand-held device (e.g., user system 14 having an NFC-enabled communication device 62) with a display screen (i.e., output device 54) capable of presenting a user key 400 encoded as a Quick Response Code 708 (i.e., a QR code). The user system 14 may create, store, and/or retrieve the user key 400, such as from the secure memory of the one or more memory 66. In one embodiment, the user 608, upon presenting the user system 14 to conduct a sale, selects a user key 400 of sufficient credit value from the user keys 400 stored, e.g., in the secure memory, to display on the output device 54 as the Quick Response Code 708 to conduct the sale. The user key 400 may be either transferred to the point of sales terminal 804 using near field communications or via an optical scanner or submit the user key 400 to an on-line commercial entity accessible through an Internet web service (e.g., via the network 26) to conduct a sales transaction. Once the user key 400 is transferred to the point of sales terminal 804 or a commercial webservice, the purchase request is forward to the financial institution 650. Once the financial institution 650 reconstitutes the authorization key 202 and validates the credit is available (such as via the reconstitution and validation process 500), the transaction request is approved, thus providing an approval message on the point of sales terminal 804 or to the commercial web service website page.

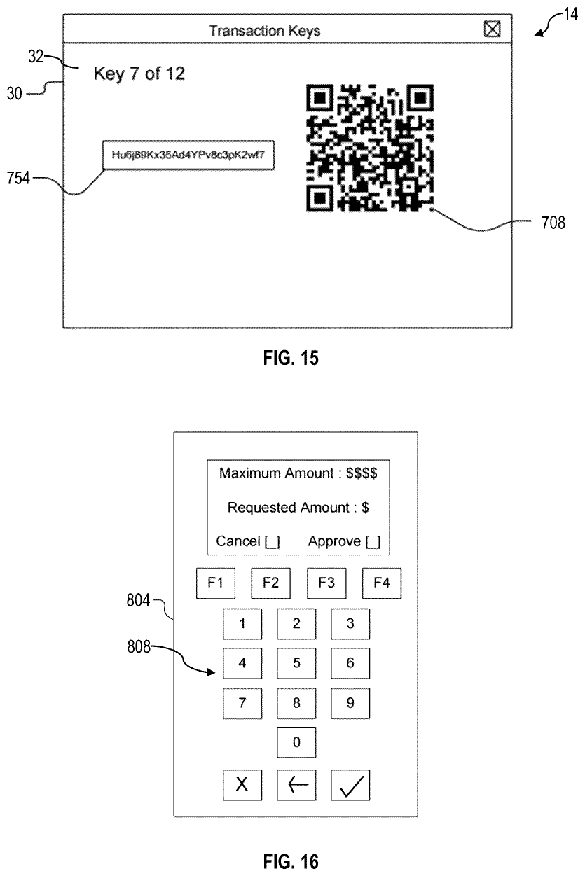

Referring now to FIG. 15, shown therein is a diagram of an exemplary embodiment of the user application 30 displayed on the output device 54 of the user system 14 constructed in accordance with the present disclosure. The user application 30 may be utilized by the user 608 to manage the user keys 400. In one embodiment, the user application 30 enables the user 608 to create, delete, and/or distribute the authentication keysets 202 to registered devices and to provide the user interface 32 to inspect the user key 400 in multiple forms such as a text string 754 and the Quick Response Code 708. The user application 30, executed by the processor 58 of the user system 14 can interface with online web commerce sites (e.g., via the network 26) and provide the user key 400 in the form of the Quick Response Code 708 formulated as an image file. The Quick Response Code image file can be scanned to retrieve the user key 400 and/or the image file may include embedded meta-data, which may provide user information to complete the financial transaction. The processor 58 may transfer the user information to the online web commerce site and auto-populate the user information on the online web commerce site, thereby negating the need of the online web commerce site to retain the user information for future use.

Referring now to FIG. 16, shown therein is a diagram of an exemplary embodiment of the point of sales terminal 804 constructed in accordance with the present disclosure. The point of sales terminal 804 may be provided by a vendor 640. In one embodiment, the point of sales terminal 804 may receive the user key 400 from the user system 14. For example, the point of sales terminal 804 may receive the user key 400 via one or more of: NFC (whereby the user 608 may present the registered device having NFC enabled to the point of sales terminal 804 and may transfer the user key 400 to the point of sales terminal 804); an optical scanner input (whereby the point of sales terminal 804 includes a QR code scanner that is operable to scan the Quick Response Code 708 provided on the output device 54 of the user system 14); and a manual input device whereby the user 608 may manually input the user key 400 via a keyboard similar to keypad 808 or another input device constructed in accordance with the one or more input device 50. In other embodiments, the user 608 may manually input the user key 400 via an audible input device, such as via a microphone.

In some embodiments, the user 608 may select the user key 400 used by making a selection on the user system 14 prior to presenting the user system 14 to the point of sales terminal 804. In other embodiments, upon presenting the user system 14 to the point of sales terminal 804 the point of sales terminal 804 provides a signal to the user system 14 indicative of the sales amount and the user application 30 executed by the processor 58 causes the processor 58 to select a particular user key 400, stored, e.g., in the secure memory, having a credit value greater than or equal to the sales amount and to present that particular user key 400 to the point of sales terminal 804.

Once the user key 400 is transferred to the point of sales terminal 804, the purchase request is forward to the financial institution 650. In some embodiments, the user 608 may be provided with an additional opportunity to approve the financial transaction after the user key 400 is transferred to the point of sales terminal 804 but before the point of sales terminal 804 forwards the purchase request to the financial institution 650.

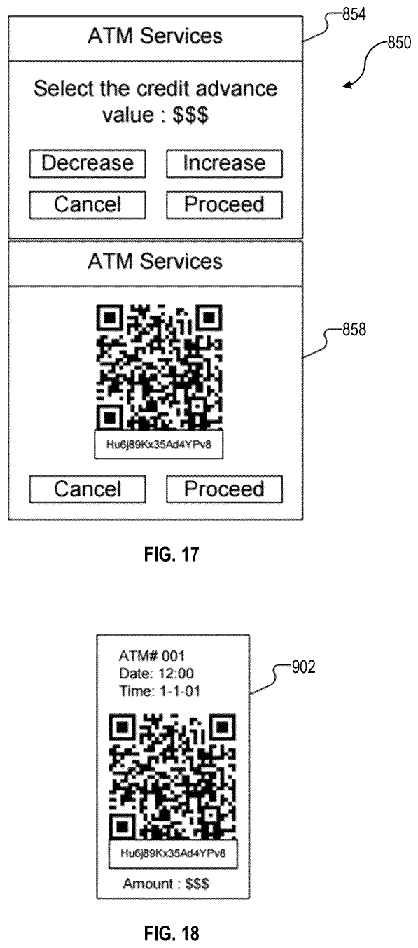

Referring now to FIG. 17, shown therein is a diagram of an exemplary embodiment of an automatic teller machine 850 constructed in accordance with the present disclosure. As shown, the automatic teller machine 850 includes an ATM application 854 that is enabled to use the segmented authentication keys. The ATM application 854 provides the ability to create and/or distribute the authentication keysets 202 to the user system 14 and the financial system 22 as the user key 400 and the finance key 404 may be consumed and need regeneration. Once the authentication keysets 202 in the keyset book 222 are reloaded, i.e., the user keys 400 are transmitted to the user system 14 and the finance keys 404 are transmitted to the financial system 22, the ATM application 854 may further distribute a credit advance in the form of a printed Quick Response Code on an automatic teller machine receipt 902 as presented in FIG. 18, below, which will allow a single transaction for a limited credit value to be used by anyone in possession of the automatic teller receipt 902. In this way, the printed Quick Response Code may take on properties similar to paper currency.

### Illustrative Embodiments

The following is a number list of clauses of non-limiting illustrative embodiments of the concepts disclosed herein:

Clause 1. A user system, comprising:
a processor; and
a memory, comprising a non-transitory processor-readable medium, storing processor-executable instructions, that when executed by the processor, cause the processor to:
   transmit a unique system identifier to a finance system;
   receive a device identification code from the finance system and store the device identification code in the memory, the device identification code being associated with a user account having a credit account number;
   generate a keyset book having one or more authentication keyset based on an authorization code comprising a user key portion and a finance key portion; and a tracking field having at least the device identification code;
   decompose at least one authentication keyset of the one or more authentication keyset into a user key and a finance key, the user key having the tracking field, the user key portion, a parity value and a user validity code, and the finance key having the tracking field, the finance key portion, one or more CRC bit, and a finance validity code;
   store the user key in the memory;
   transmit the finance key to the finance system;
   receive an input indicative of a transaction request with a vendor;
   initialize the transaction request with the finance system by transmitting the user key to the vendor; and
   receive an approval of the transaction request from the finance system having authenticated a rejoined keyset.

Clause 2. The user system of Clause 1, wherein the memory further comprises a secure memory and wherein the processor-executable instructions, when executed by the processor, further cause the processor to: store the user key in the secure memory.

Clause 3. The user system of Clause 1 further comprising an output device, and wherein the processor-executable instructions, when executed by the processor, further cause the processor to: generate a notification indicative of initialization of the transaction request with the finance system; and cause the output device to output the notification.

Clause 4. The user system of Clause 3, wherein the transaction request comprises one or more transaction property including at least a transaction value and wherein the notification further comprises an indication at least one of the one or more transaction property and the transaction value.

Clause 5. The user system of Clause 1, wherein processor-executable instructions to transmit the finance key to the finance system further causes the processor to not transmit a user PIN to the finance system.

Clause 6. The user system of Clause 1, wherein processor-executable instructions to initialize the transaction request further causes the processor to not transmit a user PIN to the vendor.

Clause 7. The user system of Clause 1, further comprising a communication device, and wherein processor-executable instructions to transmit the finance key to the finance system further causes the processor to transmit the finance key to the finance system via an insecure connection via the communication device.

Clause 8. The user system of Clause 1, further comprising an input device and wherein the processor-executable instructions, when executed by the processor, further cause the processor to: receive a credit value from the input device, the credit value indicative of a maximum credit available to the at least one authentication keyset; and wherein the tracking field further comprises the credit value.

Clause 9. The user system of Clause 8, wherein the transaction request comprises a transaction value and wherein the processor-executable instructions, when executed by the processor, further cause the processor to: initialize the transaction request with the finance system by transmitting the user key to the vendor if the credit value of the user key meets or exceeds the transaction value of the transaction request.

Clause 10. The user system of Clause 1, wherein the keyset book comprises at least a first authentication keyset and a second authentication keyset, and wherein the first authentication keyset has a first tracking field comprising at least the device identification code, a unique sequence value, and a first credit value; and the second authentication keyset has a second tracking field comprising at least the device identification code, a unique sequence value, and a second credit value which may differ from the first credit value.

Clause 11. The user system of Clause 1, wherein the processor-executable instructions, when executed by the processor, further cause the processor to: delete the finance key from the memory after transmitting the finance key to the finance system.

Clause 12. The user system of Clause 1, further comprising an output device and wherein the processor-executable instructions, when executed by the processor, further cause the processor to: encode the user key as a Quick Response Code for display on the output device.

Clause 13. The user system of Clause 1, wherein the processor-executable instructions, when executed by the processor, further cause the processor to: receive a user input indicative of a loss of a previous user system having an old user keyset corresponding with an old finance keyset; and send a signal to the financial system indicative of the loss of the previous user system to cause the financial system to delete the old finance keyset.

Clause 14. The user system of Clause 13, wherein the processor-executable instructions to send the signal to the financial system further include instructions that cause the processor to: send the signal to the financial system indicative of the loss of the previous user system to cause the financial system to delete the old finance keyset and to not cancel the credit account number.

Clause 15. The user system of Clause 1, wherein the processor-executable instructions, when executed by the processor, further cause the processor to: receive a maximum number of allowed keysets from the user; and generate a number of the one or more authentication keyset of the keyset book equal to the maximum number of allowed keysets.

Clause 16. The user system of Clause 1, further comprising a communication device, and wherein the processor-executable instructions, when executed by the processor, further cause the processor to: transmit the user key to the vendor using the communication device.

Clause 17. The user system of Clause 16, wherein processor-executable instructions to transmit the user key to the vendor further causes the processor to transmit the user key to the vendor using the communication device via an insecure connection.

Clause 18. The user system of Clause 16, wherein the communication device is a near-field communication enabled communication device, and wherein the processor-executable instructions, when executed by the processor, further cause the processor to: transmit the user key to the vendor using near-field communication.

Clause 19. The user system of Clause 16, wherein the communication device is a EMV chip, and wherein the processor-executable instructions, when executed by the processor, further cause the processor to: transmit the user key to the vendor using the EMV chip.

Clause 20. The user system of Clause 16, wherein the communication device is communicably coupled to a network to be used to conduct commercial business and wherein the processor-executable instructions, when executed by the processor, further cause the processor to: transmit the user key to the vendor using a website interface.

Clause 21. The user system of Clause 1, wherein the processor-executable instructions, when executed by the processor, further cause the processor to: delete the user key from the memory after transmitting the user key to the vendor.

Clause 22. A method, comprising:
identifying a user account by instituting a relationship between a user system operated by an account holder and a financial system;
linking the user system to the user account by determining ownership of the user system;
generating an authentication keyset based on a tracking field and an authorization code;
decomposing at least one authentication keyset into a user key and a finance key, the user key having the tracking field, a user key portion, a parity value and a user validity code, and the finance key having the tracking field, a finance key portion, one or more CRC bit, and a finance validity code;
transmitting the finance key to the finance system; and
providing the user key to a vendor as part of a transaction request to authorize the transaction request with the finance system.

Clause 23. The method of Clause 22, further comprising: storing the user key in the user system.

Clause 24. The method of Clause 22, wherein providing the user key to the vendor further includes audibly providing the user key to the vendor.

Clause 25. The method of Clause 22, wherein providing the user key to the vendor further includes inputting the user key into a vendor system as part of the transaction request.

Clause 26. The method of Clause 22, wherein providing the user key to the vendor further includes: providing an image file having embedded meta-data comprising the user key; and scanning, by a vendor system of the vendor, the image file to receive the user key as part of the transaction request.

Clause 27. The method of Clause 22, further comprising:
providing strong security of the authentication for the transaction request by decomposition of the authorization code of the at least one authentication keyset into that user key and the finance key; and
authenticating the transaction request by validating the user key received by the vendor against the finance key having the tracking field; and
wherein neither the user key nor the finance key, alone, can be used to reconstruct the other of the user key or the finance key.

Clause 28. The method of Clause 26, wherein providing the image file includes providing a QRC as the image file.

29. The method of Clause 22, wherein providing the user key to the vendor further includes: presenting a registered device to a vendor system associated with the vendor, the registered device having a secure storage storing the user key and operable to transmit the user key to the vendor system.

Clause 30. The method of Clause 29, wherein presenting the registered device includes presenting one or more of a smart card and a smart phone, the registered device being an NFC enabled registered device.

Clause 31. The method of Clause 29, wherein presenting the registered device includes presenting a smart card, the smart card having an EMV chip.

Clause 32. The method of Clause 22, further comprising:
printing the user key, the user key having a limited credit value.

Clause 33. The method of Clause 32, wherein printing the user key further includes printing the user key as a quick response code.

Clause 34. The method of Clause 33, wherein printing the user key further includes an automated teller machine printing the user key as the quick response code on a receipt.

From the above description, it is clear that the inventive concept(s) disclosed herein are well adapted to carry out the objects and to attain the advantages mentioned herein, as well as those inherent in the inventive concept(s) disclosed herein. While the embodiments of the inventive concept(s) disclosed herein have been described for purposes of this disclosure, it will be understood that numerous changes may be made and readily suggested to those skilled in the art which are accomplished within the scope and spirit of the inventive concept(s) disclosed herein.

1. A user system, comprising:
a processor; and
a memory, comprising a non-transitory processor-readable medium, storing an application having processor-executable instructions, that when executed by the processor, cause the processor to perform an institution process to:
link the user system with a user account having a credit account number by:
transmitting a unique system identifier to a finance system;
receiving a device identification code from the finance system and storing the device identification code in the memory, the device identification code being associated with the user account having the credit account number;
generate a keyset book having one or more authentication keyset based on an authorization code comprising a user key portion and a finance key portion; and a tracking field having at least the device identification code and a maximum credit value where each of the tracking field in the one or more authentication keyset being different, and each of the one or more authentication keyset configured to authorize a single transaction;
decompose at least one authentication keyset of the one or more authentication keyset into a user key and a finance key, the user key having the tracking field, the user key portion, a parity value and a user validity code, and the finance key having the tracking field, the finance key portion, one or more CRC bit, and a finance validity code;
store the user key in the memory;
wherein the application causes the processor to perform an activation process to:
transmit the finance key to the finance system;
receive an input indicative of a transaction request with a vendor;
initialize the transaction request with the finance system by transmitting the user key to the vendor as part of the transaction request to enable the vendor to submit the transaction request having the user key to the financial system; and
receive an approval of the transaction request from the finance system having authenticated a rejoined keyset within the allowable maximum credit value as set by the keyset.

2. The user system of claim 1 further comprising an output device, and wherein the processor-executable instructions, when executed by the processor, further cause the processor to:
generate a notification indicative of initialization of the transaction request with the finance system; and
cause the output device to output the notification.

3. The user system of claim 2, wherein the transaction request comprises one or more transaction property including at least a transaction value and wherein the notification further comprises an indication of at least one of the one or more transaction property and the transaction value.

4. The user system of claim 1, wherein the processor-executable instructions to transmit the finance key to the finance system further cause the processor to not transmit a user PIN to the finance system.

5. The user system of claim 1, wherein the processor-executable instructions to initialize the transaction request further cause the processor to not transmit a user PIN to the vendor.

6. The user system of claim 1, further comprising a communication device, and wherein processor-executable instructions to transmit the finance key to the finance system further causes the processor to transmit the finance key to the finance system via an insecure connection via the communication device.

7. The user system of claim 1, further comprising an input device and wherein the processor-executable instructions, when executed by the processor, further cause the processor to:
receive a credit value from the input device, the credit value indicative of the maximum credit available to the at least one authentication keyset.

8. The user system of claim 7, wherein the transaction request comprises a transaction value and wherein the processor-executable instructions, when executed by the processor, further cause the processor to:
initialize the transaction request with the finance system by transmitting the user key to the vendor if the maximum credit value of the user key meets or exceeds the transaction value of the transaction request.

9. The user system of claim 1, wherein the keyset book comprises at least a first authentication keyset and a second authentication keyset, and wherein the first authentication keyset has a first tracking field comprising at least the device identification code, a first unique sequence value, and a first credit value; and the second authentication keyset has a second tracking field comprising at least the device identification code, a second unique sequence value different from the first unique sequence number, and a second credit value which may differ from the first credit value.

10. The user system of claim 1, wherein the processor-executable instructions, when executed by the processor, further cause the processor to:
delete the finance key from the memory after transmitting the finance key to the finance system.

11. The user system of claim 1, further comprising an output device and wherein the processor-executable instructions, when executed by the processor, further cause the processor to:
encode the user key as a Quick Response Code for display on the output device.

12. The user system of claim 1, wherein the processor-executable instructions, when executed by the processor, further cause the processor to:
receive a user input indicative of a loss of a previous user system having an old user keyset corresponding with an old finance keyset; and
send a signal to the financial system indicative of the loss of the previous user system to cause the financial system to delete the old finance keyset.

13. The user system of claim 12, wherein the processor-executable instructions to send the signal to the financial system further include instructions that cause the processor to:
send the signal to the financial system indicative of the loss of the previous user system to cause the financial system to delete the old finance keyset and to not cancel the credit account number.

14. The user system of claim 1, further comprising a communication device, and wherein the processor-executable instructions, when executed by the processor, further cause the processor to:
transmit the user key to the vendor using the communication device.

15. The user system of claim 14, wherein processor-executable instructions to transmit the user key to the vendor further causes the processor to transmit the user key to the vendor using the communication device via an insecure connection.

16. The user system of claim 14, wherein the communication device is a near-field communication enabled communication device, and wherein the processor-executable instructions, when executed by the processor, further cause the processor to:
transmit the user key to the vendor using near-field communication.

17. The user system of claim 14, wherein the communication device is a EMV chip, and wherein the processor-executable instructions, when executed by the processor, further cause the processor to:
transmit the user key to the vendor using the EMV chip.

18. The user system of claim 14, wherein the communication device is communicably coupled to a network to be used to conduct commercial business and wherein the processor-executable instructions, when executed by the processor, further cause the processor to:
transmit the user key to the vendor using a website interface.

19. The user system of claim 1, wherein the processor-executable instructions, when executed by the processor, further cause the processor to:
delete the user key from the memory after transmitting the user key to the vendor.

20. A method, comprising:
identifying a user account by instituting a relationship between a user system operated by an account holder and a financial system;
linking the user system to the user account by determining ownership of the user system;
generating an authentication keyset based on a tracking field and an authorization code;
decomposing at least one authentication keyset into a user key and a finance key, the user key having the tracking field, a user key portion, a parity value and a user validity code, and the finance key having the tracking field, a finance key portion, one or more CRC bit, and a finance validity code;
transmitting the finance key to the finance system; and
providing the user key to a vendor as part of a transaction request to authorize the transaction request with the finance system.

21. The method of claim 20, wherein providing the user key to the vendor further includes inputting the user key into a vendor system as part of the transaction request.

22. The method of claim 20, wherein providing the user key to the vendor further includes:
providing an image file having embedded meta-data comprising the user key; and
scanning, by a vendor system of the vendor, the image file to receive the user key as part of the transaction request.

23. The method of claim 22, wherein providing the image file includes providing a QRC as the image file.

24. The method of claim 20, further comprising:
providing strong security of authentication for the transaction request by decomposition of the authorization code of the at least one authentication keyset into that user key and the finance key; and
authenticating the transaction request by validating the user key received by the vendor against the finance key having the tracking field; and
wherein neither the user key nor the finance key, alone, can be used to reconstruct the other of the user key or the finance key.

25. The method of claim 20, wherein providing the user key to the vendor further includes:
presenting a registered device to a vendor system associated with the vendor, the registered device having a secure storage storing the user key and operable to transmit the user key to the vendor system.

26. The method of claim 25, wherein presenting the registered device includes presenting one or more of a smart card and a smart phone, the registered device being an NFC enabled registered device.

27. The method of claim 25, wherein presenting the registered device includes presenting a smart card, the smart card having an EMV chip.

28. The method of claim 20, further comprising:
printing the user key, the user key having a limited credit value.

29. The method of claim 28, wherein printing the user key further includes printing the user key as a quick response code.

30. The method of claim 29, wherein printing the user key further includes an automated teller machine printing the user key as the quick response code on a receipt.
